(19) United States
(12) Patent Application Publication
(10) Pub. No.: US 2008/0031716 A1
(43) Pub. Date: Feb. 7, 2008

(54) Manipulator mast system with support brace

(75) Inventor: Albert J. Sturm, Stillwater, MN (US)

Correspondence Address: WESTMAN CHAMPLIN & KELLY, P.A., SUITE 1400, 900 SECOND AVENUE SOUTH, MINNEAPOLIS, MN, 55402-3319, US

(73) Assignee: PaR Systems, Inc., Shoreview, MN (US)

(21) Appl. No.: 11/498,938

(22) Filed: Aug. 2, 2006

(51) Int. Cl. B66C 23/00

(52) U.S. Cl. 414/685

(57) ABSTRACT

A telescoping mast assembly includes two longitudinal tube sections, the second disposed within the first, and adapted for telescoping motion into and out of the first longitudinal tube section. A drive assembly is joined to the first longitudinal tube section and to the second longitudinal tube section and operably configured to drive the second longitudinal tube section relative to the first longitudinal tube section. A support brace is mounted under the second longitudinal tube section, and is configured to help support the weight of the telescoping mast and reduce the torque on the telescoping mast at the base due to the large mass of the mast plus its cargo at often a large radius of extension. This thereby enables the telescoping mast to handle larger masses at longer radii of extension with high levels of performance and reliability.

### BACKGROUND

Removing large and/or heavy items such as pallets from storage and transportation containers particularly in situations where the container is moving such as on a deck of a ship is at best difficult. An improved system and/or method to address this problem are needed.

### SUMMARY OF THE INVENTION

According to one illustrative embodiment, a telescoping mast assembly includes two longitudinal tube sections, the second disposed within the first, and adapted for telescoping motion into and out of the first longitudinal tube section. A drive assembly is joined to the first longitudinal tube section and to the second longitudinal tube section and operably configured to drive the second longitudinal tube section relative to the first longitudinal tube section. A support brace is mounted under the second longitudinal tube section, and is configured to help support the weight of the telescoping mast and its cargo and reduce the torque on the telescoping mast at the base due to the large mass of the mast plus its cargo at often a large radius of extension. This thereby enables the telescoping mast to handle larger masses at longer radii of extension with high levels of performance and reliability.

### BRIEF DESCRIPTION OF THE DRAWINGS

FIG. 1 is a side sectional view of a telescoping mast assembly in an extended position, according to one illustrative embodiment.

FIG. 2 is a top sectional view of a telescoping mast assembly in an extended position, according to one illustrative embodiment.

### DETAILED DESCRIPTION OF ILLUSTRATIVE EMBODIMENTS

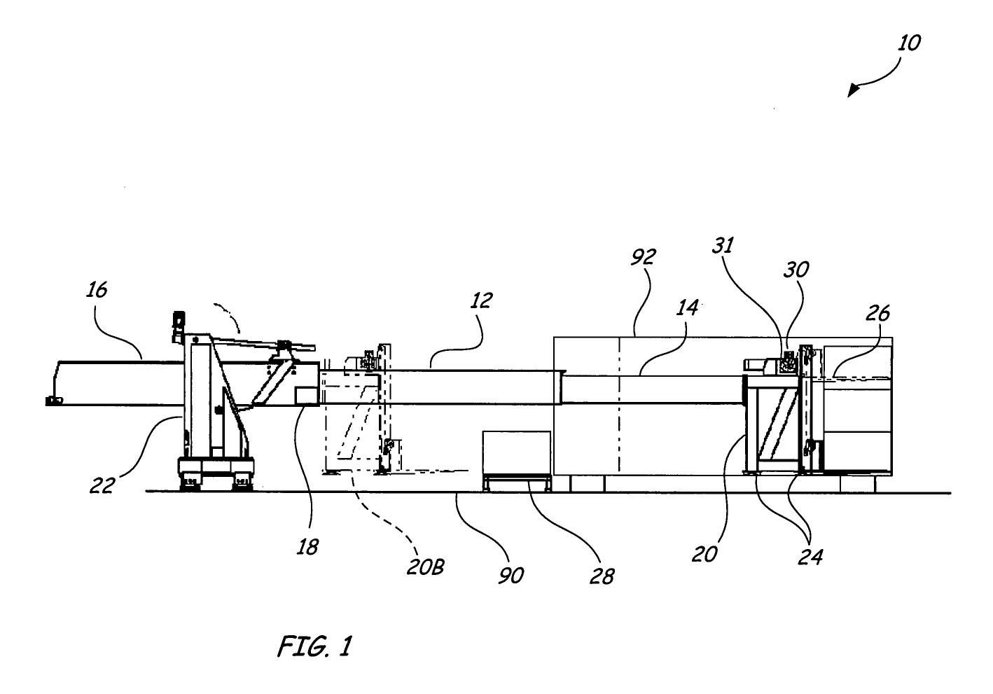

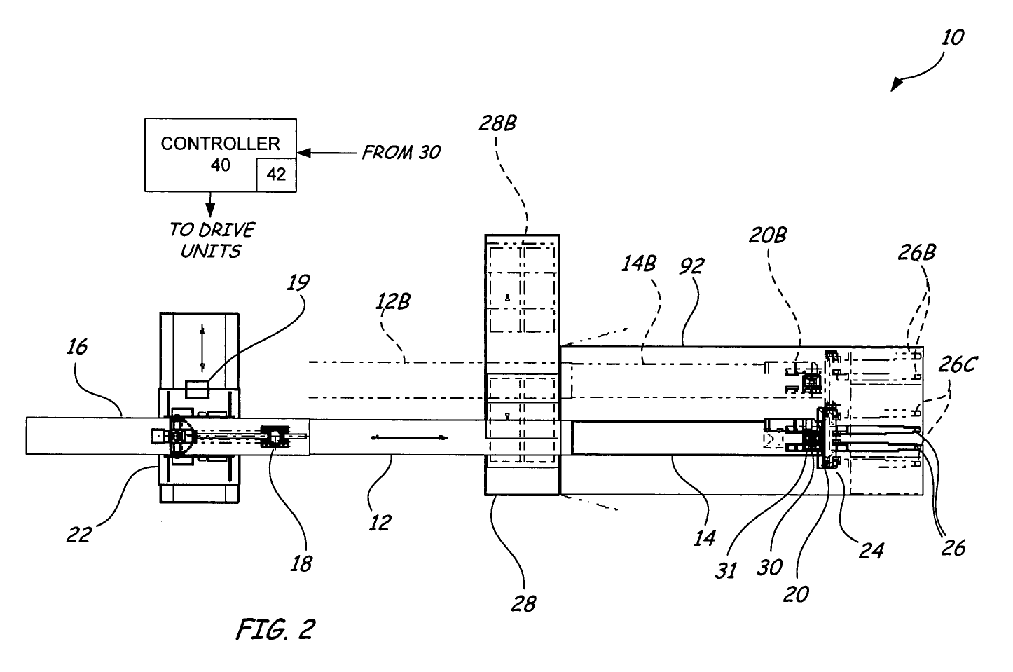

FIG. 1 depicts a side sectional view of a telescoping mast assembly 10 in an extended position, according to one illustrative embodiment. FIG. 2 is a top sectional view of telescoping mast assembly 10 in an extended position. Telescoping mast assembly 10 includes first longitudinal tube section 12 and second longitudinal tube section 14. Second longitudinal tube section 14 is disposed within the first longitudinal tube section 12, and adapted for telescoping motion into and out of the first longitudinal tube section. A drive assembly 18 is joined to the first longitudinal tube section 12 and to the second longitudinal tube section 14 and operably configured to drive the second longitudinal tube section 14 relative to the first longitudinal tube section 12.

The telescoping mast assembly 10 may include any number of tube sections, illustratively also including a third longitudinal tube section 16, configured such that the first longitudinal tube section 12 is disposed within the third longitudinal tube section 16 and adapted for telescoping motion into and out of the third longitudinal tube section 16. In the embodiment illustrated, the tube section 16 is the base tube section and is typically fixed. In one embodiment, telescoping mast assembly 10 may also include a translatable base 22 on which the third longitudinal tube section 16, or the base tube section, is mounted. A translated position for first and second tube sections 12 and 14 due to a potential lateral translation of base 22 is depicted at 12B and 14B in FIG. 2, for example. If desired base 22 can also be translatable in the direction of mast extension, as well as could pivot if desired.

At this point it should be mentioned that any of the motions of the mast, including extension (drive assembly 18)/translation/pivoting (represented as drive assembly 19) can be provided by suitable drive units such as actuators (pneumatic, hydraulic and/or electric) as well as actuators comprising mechanical gears, screws, etc. In one embodiment, the mast and/or the drive unit thereof for extension can be similar that as described U.S. Pat. Nos. 5,465,854 and 6,026,970, which are incorporated herein by reference in their entirety.

A support brace 20 is mounted under the second longitudinal tube section 14, and is configured to help support the weight of the telescoping mast 10 and reduce the torque on the telescoping mast 10 at the base 22 due to the large mass of the mast plus any cargo it may be carrying at the end of the distal second longitudinal tube section 14, at often a large radius of extension. Support brace 20 thereby enables the telescoping mast 10 to handle larger masses at longer radii of extension with high levels of performance and reliability.

Support brace 20 is also depicted in dotted lines at 20B when the longitudinal base sections 12, 14 are in a potential retracted position. Support brace 20 may include a means 24 for translating on a floor surface 90. The means 24 for translation of support brace 20 may be passive, as guided by the controlled extensions, retractions, and other motions of the second longitudinal tube section 14 to which it is mounted, in one illustrative embodiment. Support brace 20 may also have an independent means of powered translation, in another embodiment. The means 24 for translating on a floor surface 90 may include any of a wide variety of forms, such as but not limited to coasters or air bearings, for example.

The telescoping mast assembly 10 may further include an end effector 26 mounted on a distal end of the second longitudinal tube section 14, in one illustrative embodiment. Effector 26 is effective at grabbing, lifting and or otherwise supporting target subjects as they are pulled out of the shipping container 92. The effector 26 may be configured with a lifting mechanism 31 (vertical displacement) and/or a lateral motion mechanism for side-to-side movement, or other modes of powered articulation, to enable the telescoping mast assembly to easily engage and manipulate target subjects in any orientation. Any of the motions of the lifting mechanism can be provided by suitable drive units such as actuators (pneumatic, hydraulic and/or electric) as well as actuators comprising mechanical gears, screws, etc. In FIG. 2, dotted lines 26C show movement of the mechanism 24 side-to-side as controlled by movement of the mast itself; however similar movements can be made on the mechanism 24, while the mast is stationary, or even pivots.

The effector 26 may include any of a wide variety of different forms in different embodiments. For example, the effector 26 may include a fork such as on a forklift with tines (as illustrated); a vacuum grab mechanism that applies a vacuum suction to a surface of a target subject to pick it up; a jaw grab mechanism which is capable of clenching or pinching a target subject on its top and bottom or on its sides, for example; or a spatula configured to fit between target subjects and lift one off of another, among other possible forms.

The telescoping mast assembly 10 may be configured to operate with a shuttle mechanism 28 configured to receive target subject loads from the effector 26, and to shuttle those target subject loads to a subsequent destination, in one illustrative embodiment. FIG. 2 depicts a translated shuttle subject load at 28B, for example.

Vision/proximity devices 30 can be located at the end of tube 14 to help in facilitating acquisition of the target subject. Signals from devices 30 can be provided to a controller 40 having in one embodiment an interface 42 (display, joystick, etc.) allowing an operator to manually control the mast, lift mechanism, etc. In another embodiment, controller 40 can be configured to automatically locate and retrieve target subjects. For example, such a vision system, or other devices, in combination with the controller 40 can be used to adaptively locate boxes that may have shifted during transport, for example.

Although the present invention has been described with reference to particular embodiments, workers skilled in the art will recognize that changes may be made in form and detail without departing from the spirit and scope of the invention.

What is claimed is:

1. A telescoping mast assembly comprising:
a first longitudinal tube section;
a second longitudinal tube section disposed within the first longitudinal tube section and adapted for telescoping motion into and out of the first longitudinal tube section;
a drive assembly joined to the first longitudinal tube section and to the second longitudinal tube section and operably configured to drive the second longitudinal tube section relative to the first longitudinal tube section; and
a support brace mounted under the second longitudinal tube section.

2. The telescoping mast assembly of claim 1, wherein the support brace comprises means for translating on a floor surface.

3. The telescoping mast assembly of claim 2, wherein the means for translating on a floor surface comprises coasters.

4. The telescoping mast assembly of claim 2, wherein the means for translating on a floor surface comprises air bearings.

5. The telescoping mast assembly of claim 1, wherein the support brace is mounted under a distal end of the second longitudinal tube section relative to the base.

6. The telescoping mast assembly of claim 1, further comprising an effector mounted on a distal end of the second longitudinal tube section.

7. The telescoping mast assembly of claim 6, further comprising a shuttle mechanism configured to receive loads from the effector.

8. The telescoping mast assembly of claim 6, wherein the effector is configured with a lifting mechanism.

9. The telescoping mast assembly of claim 6, wherein the effector is configured with a lateral motion mechanism.

10. The telescoping mast assembly of claim 6, wherein the effector comprises a fork.

11. The telescoping mast assembly of claim 6, wherein the effector comprises a vacuum grab mechanism.

12. The telescoping mast assembly of claim 6, wherein the effector comprises a jaw grab mechanism.

13. The telescoping mast assembly of claim 6, wherein the effector comprises a spatula.

14. The telescoping mast assembly of claim 6, wherein the effector comprises a vision system configured to optically detect lift targets.

15. The telescoping mast assembly of claim 1, further comprising a third longitudinal tube section, configured such that the first longitudinal tube section is disposed within the third longitudinal tube section and adapted for telescoping motion into and out of the third longitudinal tube section.

16. The telescoping mast assembly of claim 15, further comprising a translatable base on which the third longitudinal tube section is mounted.
